(19) United States
(12) Patent Application Publication
(10) Pub. No.: US 2006/0236871 A1
(43) Pub. Date: Oct. 26, 2006

(54) Single portion cartridge

(75) Inventors: Rudiger Ternite, Hamburg (DE); Klaus-Dieter Mund, Hamburg (DE); Hartwig Meyer-Ruhstrat, Stelle (DE); Ingo Lantz, Hamburg (DE)

Correspondence Address: NIXON & VANDERHYE, PC, 901 NORTH GLEBE ROAD, 11TH FLOOR, ARLINGTON, VA, 22203, US

(73) Assignee: TCHIBO GMBH, Hamburg (DE)

(21) Appl. No.: 11/399,599

(22) Filed: Apr. 7, 2006

(30) Foreign Application Priority Data
Apr. 8, 2005 (DE) 10 2005 016 297.5

(51) Int. Cl. A47J 31/00

(52) U.S. Cl. 99/295

(57) ABSTRACT

A single portion cartridge (1), which is suitable in particular for brewing a portion of a coffee beverage, has a cartridge cover (6) and a cartridge base (4) and in the state in which it is supplied is closed on all sides. It contains a particulate beverage substance which can be extracted by means of water. Arranged between the cartridge cover (6) and the beverage substance is a distributing device (8) and/or between the beverage substance and the cartridge base (4) a screening device (9). The distributing device (8) and/or the screening device (9) has a supporting structure (20, 10), which is provided with at least one opening (26, 16), which is covered by a textile fabric (34, 30).

The invention relates to a single portion cartridge, which is suitable in particular for brewing single portions of coffee (one cup or two cups of coffee) in a coffee maker intended for the use of single portion cartridges.

EP 1 344 722 A1 describes a single portion cartridge which comprises a cartridge cover and a cartridge base, in the state in which it is supplied is closed on all sides and contains a particulate coffee substance which can be extracted by means of water. In this case, a distributing device is arranged between the cartridge cover and the coffee substance and a collecting device is arranged between the coffee substance and the cartridge base. The distributing device and the collecting device have in each case a number of openings and embossments to form liquid channels. This single portion cartridge is used in a special coffee maker, the cartridge cover and the cartridge base being perforated when the single portion cartridge is inserted into the maker or during the brewing operation. In this way, hot water passes through an opening in the cartridge cover onto the distributing device and is distributed essentially uniformly by the latter, so that the coffee substance in the single portion cartridge can be extracted largely uniformly. The finished beverage is passed by the collecting device to an opening in the cartridge base, where it leaves the single portion cartridge and can be caught by a vessel (for example a cup).

In the case of the already known single portion cartridge, coffee particles can be flushed out from the single portion cartridge through the openings in the collecting device or in the distributing device, so that the coffee particles get into the vessel or onto the cartridge cover. This may be perceived as disadvantageous by the consumer.

An object of the invention is to improve the already known single portion cartridge, so that for example the escape of particles of the beverage substance from the single portion cartridge is minimized to the greatest extent.

This object is achieved by a single portion cartridge with the features of Claim 1. Advantageous configurations of the invention are provided by the subclaims. Claim 19 relates to a method for producing an embodiment of the single portion cartridge.

The single portion cartridge according to the invention has a cartridge cover and a cartridge base, in the state in which it is supplied is closed on all sides and contains a particulate beverage substance which can be extracted by means of water. A distributing device is arranged between the cartridge cover and the beverage substance, and/or a screening device is arranged between the beverage substance and the cartridge base. The distributing device and/or the screening device has a supporting structure, which is provided with at least one opening, which is covered by a textile fabric.

A distributing device with a supporting structure, the openings of which are covered by a textile fabric, distributes brewing water entering the single portion cartridge by the brewing water passing through pores in the textile fabric and thereby penetrating into the beverage substance of the single portion cartridge over a relatively large entry area.

A screening device in which the openings of a supporting structure are covered by a textile fabric prevents to the greatest extent coffee particles from being washed out from the single portion cartridge if the pores in the textile fabric are smaller than the majority of the coffee particles. In this case, the screening device has a filtering function, although it does not consist of conventional filter paper. At the same time, the screening device serves as a collecting device, in order to allow the beverage to leave the single portion cartridge.

The textile fabric (of the distributing device and/or of the screening device) preferably comprises a woven or nonwoven fabric. Mixed forms are likewise conceivable, for example multilayered formations in which, for example, a layer of nonwoven fabric is applied to a layer of woven fabric. Furthermore, the textile fabric may also be formed, for example, as a formed-loop, crochet-galloon or drawn-loop knitted fabric.

Suitable materials for the textile fabric are filaments and/or fibres of plastics and/or natural substances, but also metals. Suitable plastics are, for example, polyolefins (in particular polypropylene and polyethylene) and also polyamides. The suitable natural substances include, in particular, cellulose, but it is also possible for example for regenerated cellulose (for example viscose) to be used. Among the metals, high-grade steel is particularly suitable. It is also conceivable to use mixtures of different materials, also mixtures of plastics and natural substances or with metal filaments.

The textile fabric preferably has pores with a size in the range from 10 μm to 500 μm. Preferred ranges lie from 10 μm to 200 μm or from 30 μm to 150 μm. All other intervals with a lower limit greater than or equal to 10 μm and an upper limit less than or equal to 500 μm are expressly considered as also disclosed here. The pores (meshes) may be round or angular.

The textile fabric preferably contains filaments of a thickness in the range from 10 μm to 500 μm, with particular preference in the range from 10 μm to 200 μm or from 30 μm to 150 μm. Here, too, all intervals or ranges with a lower limit greater than or equal to 10 μm and an upper limit less than or equal to 500 μm are expressly considered as also disclosed. The filaments may also be formed as double or multiple filaments (fanned out or twisted).

In the case of preferred configurations of the invention, the supporting structure has radially extending ribs, or the supporting structure contains an essentially planar disc with apertures. In this case, regions between the ribs or apertures are covered by textile fabric. Ribs may also be arranged on a disc-like supporting structure as reinforcements. Furthermore, it is advantageous if the supporting structure has a reinforcing edge at its periphery, for example an edge which protrudes from the disc-like structure. Many, widely varied configurations are conceivable for the supporting structure, as illustrated further below on the basis of exemplary embodiments.

In the case of a preferred embodiment, the supporting structure has in its central region a protuberance, which is designed for receiving a spike (or a piercing means) on a coffee maker adapted for receiving the single portion cartridge. This applies both to a supporting structure of the distributing device and to a supporting structure of the screening device. Single portion cartridges with protuberances of this type are intended for coffee makers in which a spike is used to perforate the single portion cartridge on the cartridge cover and/or on the cartridge base. The respective spike is intended only to penetrate through the cartridge cover or the cartridge base, but not damage the distributing device or the screening device, for which reason the distributing device or the screening device is set back into the interior of the single portion cartridge at the place where the spike penetrates, that is in the region of the respective protuberance.

The supporting structure is preferably produced as an injection moulding of plastic, which has high precision and is inexpensive. In particular, it is also possible in this way to form a protuberance as part of the supporting structure, so that the openings can extend in planar zones of the supporting structure and so can be covered unproblematically by a textile fabric, without the textile fabric having to be deformed three-dimensionally. The supporting structure may also be produced as a thermoformed or punched part, preferably of plastic.

There are various possibilities for connecting the textile fabric to a supporting structure. For instance, the textile fabric may be placed on the supporting structure (from above or from below) and fastened to it, for example by firm adhesive attachment, firm welding or stamping, combinations of various types of fastening also being conceivable.

Another possibility is to embed the textile fabric in the supporting structure. In the case of a preferred method for producing a single portion cartridge with a textile fabric embedded in a supporting structure, in one method step a textile fabric is placed in an injection mould for the supporting structure of the distributing device or of the screening device and integrated in the distributing device or the screening device by injecting plastics moulding compound into the mould. This method step can be integrated well in the production process, and the textile fabric is securely connected to the respective supporting structure in the resultant distributing or screening device, without leaving any cracks or gaps through which particles of the beverage substance could escape.

In the case of an advantageous configuration of the invention, the cartridge base has an artificially weakened location. The cartridge base is to be understood as meaning the side of the single portion cartridge from which the beverage leaves the single portion cartridge, that is to say irrespective of whether the cartridge base is for example located at the top or bottom when a single portion cartridge is inserted in a coffee maker. The artificially weakened location makes it easier for the cartridge base to be pierced in the coffee maker. This applies in particular to designs in which the cartridge cover is penetrated by a spike when the single portion cartridge is placed in the coffee maker, but the cartridge base is not initially penetrated. While the brewing water subsequently builds up a pressure inside the cartridge, the cartridge base bulges out, until it is perforated by a spike or some other piercing device. If the pressure increase is relatively small, for example as desired when brewing filter coffee, the cartridge base is deformed only relatively slightly and would not be readily pierced without the presence of an artificially weakened location. The artificially weakened location preferably comprises a piece of foil, which is arranged where the spike or the piercing means of the coffee maker is located, that is to say for example in the central region of the cartridge base.

Beverage substances of many types are conceivable. Ground coffee, which is chosen for example for brewing filter coffee, caffe crema or espresso, is preferred. Furthermore, the single portion cartridge can be optimized for the respective coffee beverage by the configuration of the distributing device and/or of the screening device, in particular if it is used in a coffee maker which operates in a pressure range that is optimized for the coffee beverage. For instance, in the case of filter coffee, with which the typical pressure build-up in the single portion cartridge lies in the range from approximately 3 bar to 9 bar, it is undesired to have a froth on top, in the case of caffe crema (typical pressure build-up in the single portion cartridge in the range from approximately 9 bar to 13 bar) a froth is to be produced on top during brewing. This can be controlled not only by the pressure used during brewing but also by means of the form of the distributing device or the screening device. When brewing espresso, the pressure is traditionally high (typical pressure build-up in the single portion cartridge in the range from approximately 13 bar to 18 bar).

The beverage substance may also comprise substances other than ground coffee, for example tea, chocolate, instant soup, milk powder, liquid milk (as an addition), etc. or mixtures of substances of this type, including with ground coffee.

The invention is further described below on the basis of exemplary embodiments. In the drawings:

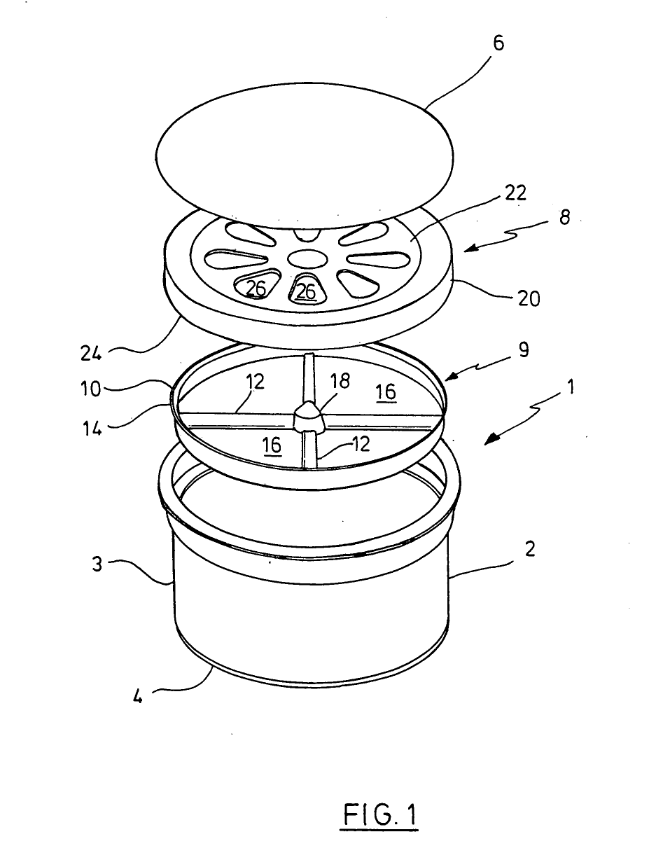

FIG. 1 shows an exploded view of an embodiment of the single portion cartridge according to the invention,

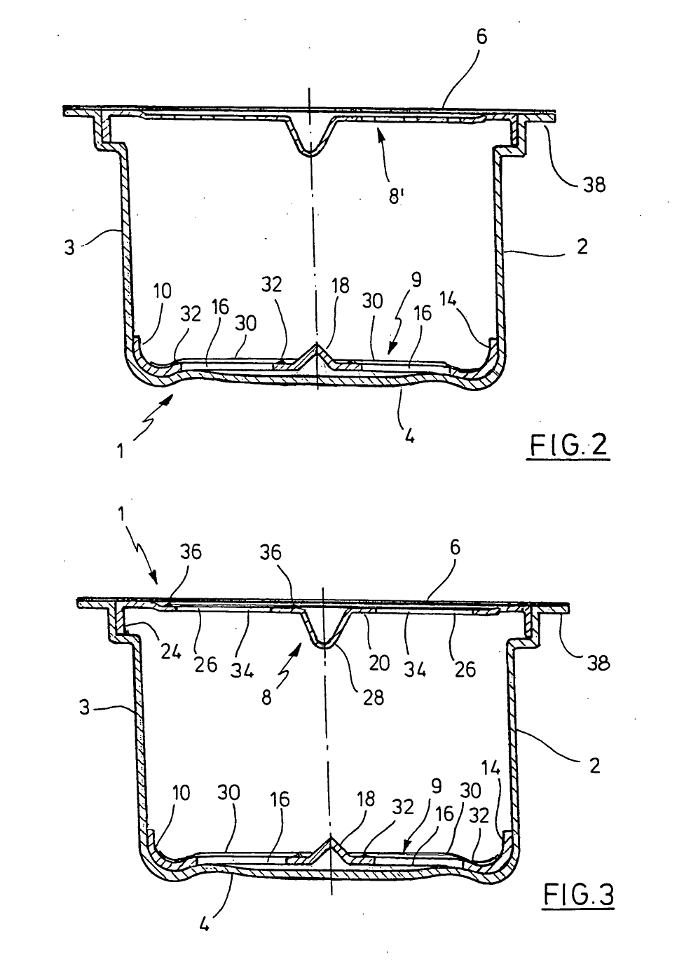

FIG. 2 shows a longitudinal section through a further embodiment of the single portion cartridge according to the invention,

FIG. 3 shows a longitudinal section through the embodiment of the single portion cartridge according to the invention according to FIG. 1,

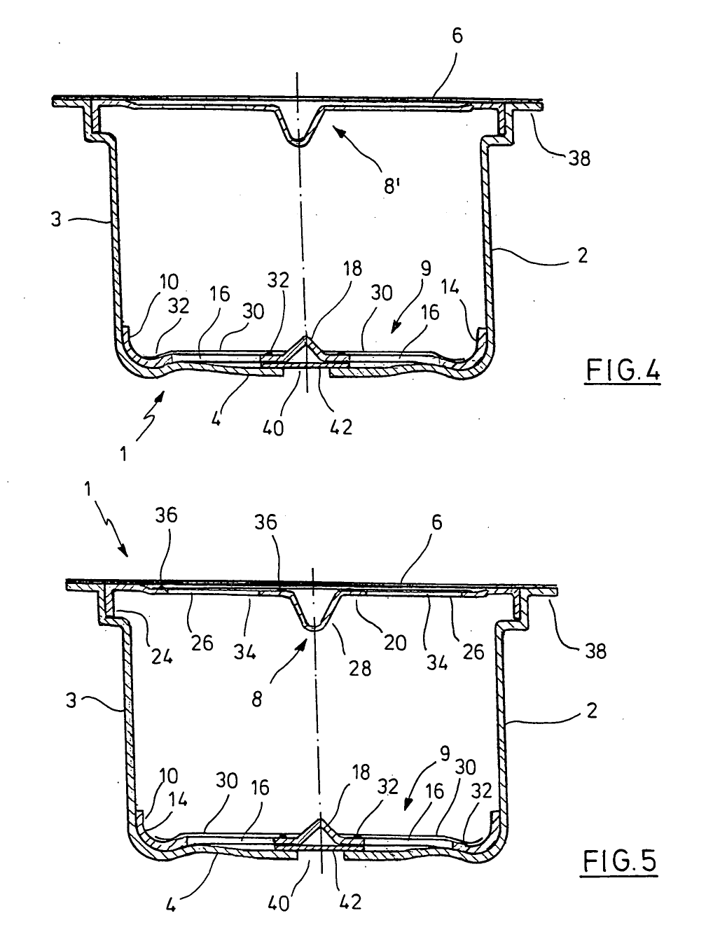

FIG. 4 shows a longitudinal section through a further embodiment of the single portion cartridge according to the invention,

FIG. 5 shows a longitudinal section through a further embodiment of the single portion cartridge according to the invention,

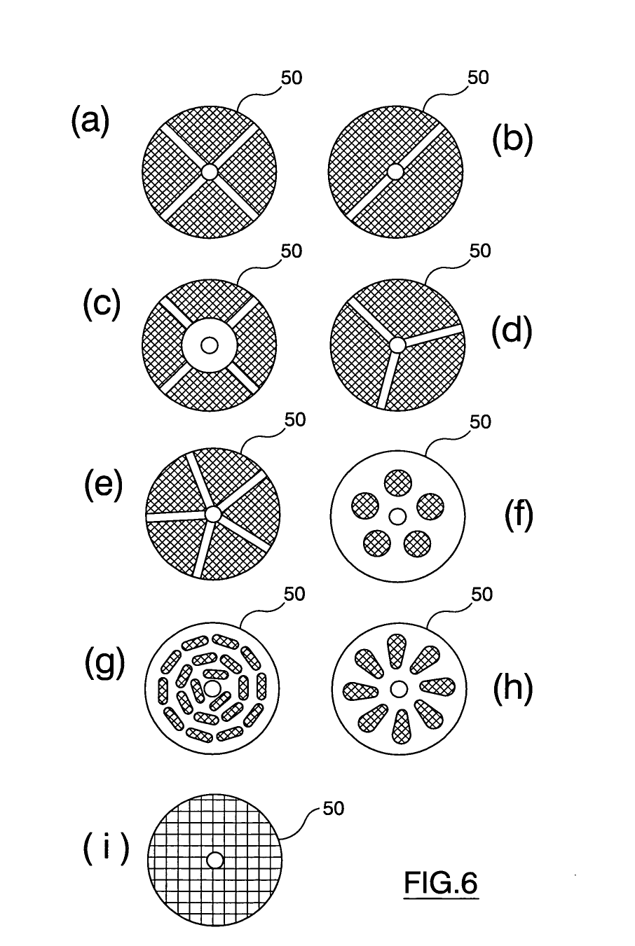

FIG. 6 shows in parts (a) to (i) plan views of various embodiments of a distributing device and a screening device in the case of the single portion cartridge according to the invention,

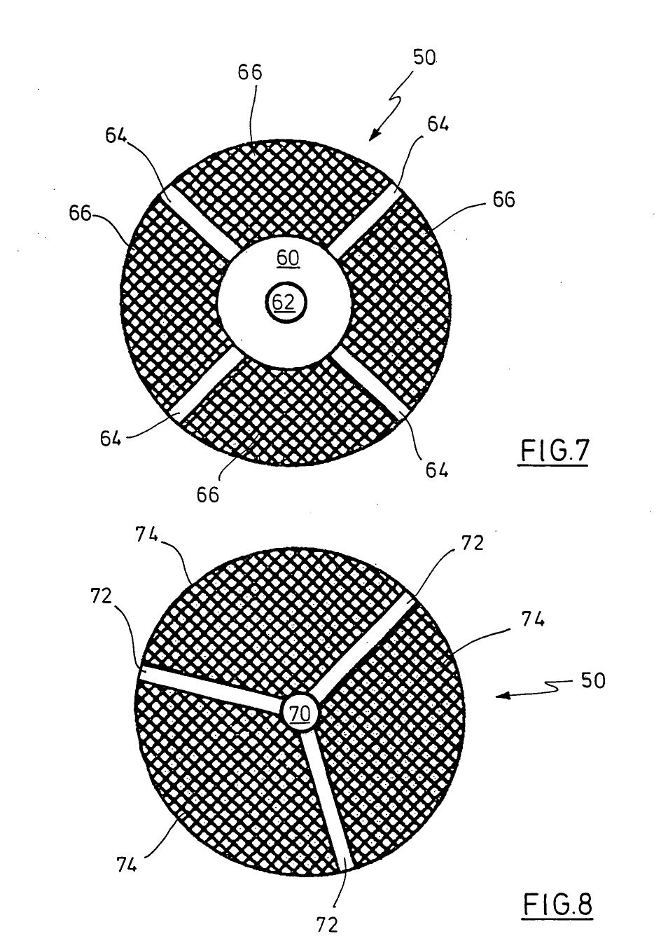

FIG. 7 shows an enlarged view according to FIG. 6(c),

FIG. 8 shows an enlarged view according to FIG. 6(d),

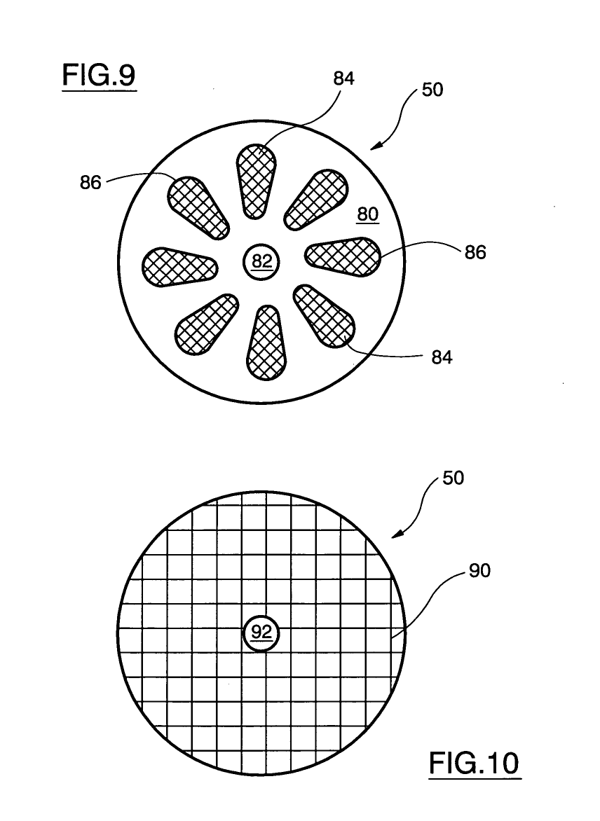

FIG. 9 shows an enlarged view according to FIG. 6(h) and

FIG. 10 shows an enlarged view according to FIG. 6(i).

FIG. 1 illustrates an embodiment of a single portion cartridge 1 in an exploded view.

The single portion cartridge 1 has in the exemplary embodiment a cylindrical basic body 2 with a wall 3 and a cartridge base 4. The cartridge cover 6 is formed as a separate part and, after the single portion cartridge 1 has been filled with a particulate beverage substance, is sealed at its periphery onto a flange-like, outwardly projecting edge extending from the wall 3.

Arranged in the space inside the single portion cartridge 1 in the vicinity of the cartridge cover 6 is a distributing device 8 and in the vicinity of the cartridge base 4 a screening device 9, see also FIGS. 2 to 5. The intermediate space between the distributing device 8 and the screening device 9 is filled with the particulate beverage substance, which preferably consists of ground coffee, but may also contain additional substances.

The screening device 9 has a supporting structure 10, which in the exemplary embodiment includes four radially extending ribs 12 and a peripheral reinforcing edge 14. Between the ribs 12 and the reinforcing edge 14 there are four apertures 16. A conical protuberance 18 forms the central region of the supporting structure 10, see also FIGS. 2 to 5. The apertures 16 are covered by a textile fabric, which in the exemplary embodiment is formed as a woven fabric.

The distributing device 8 has a supporting structure 20, which comprises a planar disc 22, from the outer periphery of which a reinforcing edge 24 projects. The disc 22 is provided with openings in the form of apertures 26 and likewise has in its central region a conical protuberance, denoted here by 28. The apertures 26 are covered by a woven fabric.

FIG. 2 shows a variant of the embodiment from FIG. 1 in longitudinal section. The distributing device, denoted here by 8′, is not constructed in the way shown in FIG. 1 but is formed in a conventional way, as described in EP 1 344 722 A1.

In FIG. 2 it can be seen how the openings 16 of the supporting structure 10 of the screening device 9 are covered by a woven fabric 30. In the exemplary embodiment, the woven fabric 30 is in one piece and has an annular form with a central clearance, which receives the protuberance 18. In the exemplary embodiment, the woven fabric 30 is fastened to the supporting structure 10 with the aid of weld points 32, to be precise in such a way that the woven fabric 30 lies against the supporting structure 10 with a sealing effect and no particles of the beverage substance can be washed out at the joins. The reinforcing edge 14 of the supporting structure 10 lies against the peripheral region of the cartridge base 4 and the lower zone of the wall 3 with a sealing effect, as can be seen in FIG. 2.

FIG. 3 shows the embodiment according to FIG. 1 in longitudinal section. In this, the apertures 26 in the disc 22 of the supporting structure 20 are covered by woven fabric 34, which is preferably likewise produced in an annular manner from one piece and is connected to the disc 22 at weld locations 36. The reinforcing edge 24 lies against a projection of the wall 3 with a sealing effect. The cartridge cover 6 is sealed on a flange 38 projecting outwards from the wall 3.

FIGS. 4 and 5 show further embodiments of the single portion cartridge, which are essentially formed in the same way as the embodiments according to FIGS. 2 and 3, for which reason the same reference numerals are also used for the sake of simplicity. As a difference from the embodiment according to FIGS. 2 and 3, the cartridge base 4 according to FIGS. 4 and 5 is in each case provided with an opening 40, which is covered by a piece of foil 42. In FIGS. 4 and 5, the piece of foil 42 is sealed on from above, but may also be fastened on the respective cartridge base from below.

In the exemplary embodiments, the basic bodies of the single portion cartridges are produced from plastic, while the cartridge covers consist of a composite foil comprising aluminium and plastic. The supporting structures of the distributing device and of the screening device are injection-moulded parts of plastic. How the woven fabric covering the openings of the respective supporting structure can be formed was already discussed at the beginning, as were alternatives to a woven fabric, for example nonwovens. In the screening device, the pores in the woven fabric should be so small that, as far as possible, no particles of the beverage substance can pass through the screening device during the brewing of the beverage.

Instead of welding, the woven fabric or the textile fabric of some other form may also be adhesively attached or stamped on, to be precise from the upper side of the respective supporting structure, but also from the underside. Furthermore, the textile fabric may be embedded in the respective supporting structure in an injection-moulding process, as discussed at the beginning.

The single portion cartridge 1 is used in a coffee maker which is specifically designed for the use of single portion cartridges. In the case of one example of a coffee maker of this type, the single portion cartridge 1 is placed in a separate cartridge holder, which is subsequently inserted into the coffee maker and locked. In this case, a spike (piercing means) penetrates through the central region of the cartridge cover 6 into the protuberance 28, without damaging the distributing device 8. Underneath the cartridge base 4 there is likewise a spike (piercing means), which however in this example does not damage the cartridge base, only scores it. Subsequently, pressurized water is passed through the opening in the cartridge cover 6 and distributed largely uniformly by the distributing device 8, so that the water can extract the beverage substance located in the single portion cartridge 1. As this happens, the pressure in the single portion cartridge 1 increases, so that the cartridge base 4 bulges out and is perforated by the spike located underneath the cartridge base 4. If the pressure increase is not particularly great, the embodiments according to FIGS. 4 and 5 should be used, in order that the spike can penetrate through the piece of foil 42 serving as the artificially weakened location. The spike is formed as a hollow spike and enters the protuberance 18 without damaging the screening device 9. Extracted beverage can therefore only pass from the single portion cartridge 1 into the hollow spike via the intact woven fabric of the screening device 9, so that beverage particles cannot undesirably leave the single portion cartridge 1.

FIG. 6 shows in parts (a) to (i) further embodiments for the distributing device or the screening device, here respectively denoted by 50, in plan view. The embodiments according to parts (a), (b), (d) and (e) are similarly constructed and are explained hereafter on the basis of FIG. 8. The embodiment according to part (c) is described on the basis of FIG. 7. The embodiments according to parts (f), (g) and (h) are likewise similarly designed and are explained on the basis of FIG. 9. FIG. 10 shows the embodiment according to part (i). In all cases, a peripheral reinforcing ring that is preferably present is not depicted.

The supporting structure as shown in FIG. 7 has a central disc 60 with a protuberance 62, from which four radial ribs 64 extend. The four openings between the ribs 64 are covered by woven fabric 66.

In the case of the embodiment in FIG. 8, there is no central disc. Extending from the protuberance 70 are three ribs 72, the intermediate spaces of which are covered by woven fabric 74. This embodiment is formed in a way similar to the screening device 9 as shown in FIG. 1.

FIG. 9 shows a supporting structure with a disc 80 and a central protuberance 82. The disc 80 has apertures 84, which are covered by woven fabric 86. This embodiment corresponds essentially to the distributing device 8 in FIG. 1.

The embodiment according to FIG. 10 has as a supporting structure a woven supporting fabric 90 with great mesh width, in the centre of which there is a protuberance 92 comprising an injection-moulded part of plastic. If this embodiment is used as a screening device, the woven supporting fabric 90 is covered with a finer woven fabric (not depicted in FIG. 10), in order to prevent particles of the beverage substance from passing through. If it is used as a distributing device, it is also possible in principle for larger pores to be used, so that in this case covering with a finer woven fabric is unnecessary.

1. Single portion cartridge,
which comprises a cartridge cover (6) and a cartridge base (4), in the state in which it is supplied is closed on all sides and contains a particulate beverage substance which can be extracted by means of water,
a distributing device (8; 50) being arranged between the cartridge cover (6) and the beverage substance, and/or a screening device (9; 50) being arranged between the beverage substance and the cartridge base (4),
the distributing device (8; 50) and/or the screening device (9; 50) having a supporting structure (20,10), which is provided with at least one opening (26, 16; 84), which is covered by a textile fabric (34,30; 66; 74; 86).

2. Single portion cartridge according to claim 1, characterized in that the textile fabric comprises a woven fabric (34, 30; 66; 74; 86).

3. Single portion cartridge according to claim 1, characterized in that the textile fabric comprises a nonwoven fabric.

4. Single portion cartridge according to claim 1, characterized in that the textile fabric (34, 30; 66; 74; 86) contains fibres and/or filaments, which comprise at least one of the materials selected from the following list:
polyolefins, polypropylene, polyethylene, polyamides, cellulose, regenerated celluloses, viscose, metals, high-grade steels.

5. Single portion cartridge according to claim 1, characterized in that the textile fabric (34, 30; 66; 74; 86) has pores with a size in the range from 10 μm to 500 μm, preferably in the range from 10 μm to 200 μm, with particular preference in the range from 30 μm to 150 μm.

6. Single portion cartridge according to claim 1, characterized in that the textile fabric (34, 30; 66; 74; 86) contains filaments of a thickness in the range from 10 μm to 500 μm, preferably in the range from 10 μm to 200 μm, with particular preference in the range from 30 μm to 150 μm.

7. Single portion cartridge according to claim 1, characterized in that the textile fabric (34, 30; 66; 74; 86) contains filaments which are formed as double or multiple filaments.

8. Single portion cartridge according to claim 1, characterized in that the supporting structure (10) has radially extending ribs (12; 64; 72).

9. Single portion cartridge according to claim 1, characterized in that the supporting structure (20) has an essentially planar disc (22; 80) with apertures (26; 84).

10. Single portion cartridge according to claim 1, characterized in that the supporting structure (20, 10) has in its central region a protuberance (28, 18; 62; 70; 82; 92), which is designed for receiving a spike on a coffee maker adapted for receiving the single portion cartridge.

11. Single portion cartridge according to claim 1, characterized in that the supporting structure (20, 10) has a reinforcing edge (24, 14) at its periphery.

12. Single portion cartridge according to claim 1, characterized in that the supporting structure (20, 10) is produced as an injection-moulded part, thermoformed part or punched part of plastic.

13. Single portion cartridge according to claim 1, characterized in that the textile fabric (34, 30; 66; 74; 86) is placed on the supporting structure (20,10) and fastened to it, preferably adhesively attached and/or welded and/or stamped on.

14. Single portion cartridge according to claim 1, characterized in that the textile fabric (66; 74; 86) is embedded in the supporting structure.

15. Single portion cartridge according to claim 1, characterized in that the cartridge base (4) has an artificially weakened location (42).

16. Single portion cartridge according to claim 15, characterized in that the artificially weakened location comprises a piece of foil (42), which is preferably arranged in the central region of the cartridge base (4).

17. Single portion cartridge according to claim 1, characterized in that the beverage substance comprises ground coffee, preferably ground coffee for the brewing of filter coffee, caffe crema or espresso.

18. Single portion cartridge according to claim 1, characterized in that the beverage substance comprises at least one of the following substances: tea, chocolate, instant soup, milk powder, liquid milk.

19. Method for producing a single portion cartridge according to claim 14, characterized in that in one method step a textile fabric (66; 74; 86) is placed in an injection mould for the supporting structure of the distributing device (50) of the single portion cartridge or in an injection mould for the supporting structure of the screening device (50) of the single portion cartridge and integrated in the distributing device (50) or the screening device (50) by injecting plastics moulding compound into the mould.
